(19) United States
(12) Patent Application Publication
(10) Pub. No.: US 2013/0024509 A1
(43) Pub. Date: Jan. 24, 2013

(54) SYSTEM AND METHOD FOR COORDINATING A SERIES OF SOCIAL ENCOUNTERS

(71) Applicant: Justin Clouse, Richmond, KY (US)

(72) Inventor: Justin Clouse, Richmond, KY (US)

(73) Assignee: TikiWho, LLC, Richmond, KY (US)

(21) Appl. No.: 13/188,545

(22) Filed: Jul. 22, 2011

(51) Int. Cl. G06F 15/16

(52) U.S. Cl. 709/204

(57) ABSTRACT

A system and method for coordinating a series of social encounters, including a computer-implemented method using a central machine having a processor, a memory, and a coordination application stored in the memory and executing in the processor, and the central machine being in communication with one or more computing devices. The method includes receiving identifying information corresponding to one or more users and correlated with respective computing devices, generating a first seating arrangement in the memory, and transmitting a first seating assignment to each of the computing devices. The method further includes receiving a first set of ratings of one or more users, processing the first set of ratings to generate a second seating arrangement, and transmitting a second seating assignment to each of the computing devices. The method optionally can further include receiving a second set of ratings, and based on the ratings, computing one or more matches.

### TECHNICAL FIELD OF THE INVENTION

This disclosure relates generally to the field of social encounters, and, in particular, to computer-implemented systems and methods for coordinating a series of social encounters at an establishment such as a restaurant.

### BACKGROUND OF THE INVENTION

Social networking, made available through websites such as Facebook and Twitter, enables individuals to connect and communicate with one another through various communication platforms and tools. While social networking is utilized effectively by millions of people across the world to connect through the internet, these connections often remain ‘virtual’ (that is, existing only within the realm of the internet and/or electronic communication) and do not result in real-world, face-to-face connections and/or interactions.

Individuals interested in developing new social connections and relationships in a real-world, face-to-face setting generally have few available options. Many people do not enjoy the experiences associated with visiting bars or nightclubs. While other social opportunities do exist, many individuals who attend struggle with the inherent awkwardness of initiating conversation with strangers.

It is with respect to these and other considerations that the disclosure made herein is presented.

### SUMMARY OF THE INVENTION

Technologies are presented herein for a system and method for coordinating a series of social encounters. According to one aspect, a computer-implemented method for coordinating a series of social encounters using a central machine is provided, the central machine having a processor, a memory, and a coordination application stored in the memory and executing in the processor, and the central machine being in communication with one or more computing devices. The method includes receiving identifying information corresponding to one or more users and correlated with respective computing devices, generating a first seating arrangement in the memory, the first seating arrangement comprising a first grouping of the users and one or more first seating assignments, and transmitting a first seating assignment to each of the computing devices. The method further includes receiving a first set of ratings of one or more users in the first grouping from computing devices of one or more users in the first grouping, processing the first set of ratings to generate a second seating arrangement in the memory, the second seating arrangement comprising a second grouping of the users that is different from the first grouping of the users and one or more second seating assignments that are different from the one or more first seating assignments, and transmitting a second seating assignment to each of the computing devices. The method further includes receiving a second set of ratings of at least one of the users from each of the computing devices, and based on at least the first set of ratings and the second set of ratings, computing one or more matches.

According to another aspect, a social encounter coordination system is provided. The system includes a processor, a control circuit operatively connected to the processor, a memory operatively connected to the control circuit and accessible by the processor, a coordination application stored in the memory and executable in the processor and a communication interface operatively connected to the control circuit and configured for communication with one or more computing devices. The coordination application, when executed by the processor, configures the control circuit to receive identifying information corresponding to one or more users and correlated with respective computing devices, generate a first seating arrangement in the memory, the first seating arrangement comprising a first grouping of the users and one or more first seating assignments, and transmit with the communication interface a first seating assignment to each of the computing devices. In addition, the coordination application, when executed by the processor, configures the control circuit to receive a first set of ratings of one or more users in the first grouping from computing devices of one or more users in the first grouping, process the first set of ratings to generate a second seating arrangement in the memory, the second seating arrangement comprising a second grouping of the users that is different from the first grouping of the users and one or more second seating assignments that are different from the one or more first seating assignments, and transmit a second seating assignment to each of the computing devices. The coordination application, when executed by the processor, also configures the control circuit to receive a second set of ratings of at least one of the users from each of the computing devices, and compute one or more matches based on at least the first set of ratings and the second set of ratings.

These and other aspects, features, and advantages can be appreciated from the accompanying description of certain embodiments of the invention and the accompanying drawing figures.

### BRIEF DESCRIPTION OF THE DRAWINGS

FIG. 1 is a high-level diagram illustrating an exemplary configuration of a social encounter coordination system;

FIG. 2 a flow diagram is described showing a routine 200 that illustrates a broad aspect of a method for coordinating a series of social encounters in accordance with one exemplary embodiment; and

FIG. 3 is a diagram representing a series of seating arrangements (ROUND 1 and ROUND 2) generated by the social encounter coordination system.

### DETAILED DESCRIPTION OF CERTAIN EMBODIMENTS OF THE INVENTION

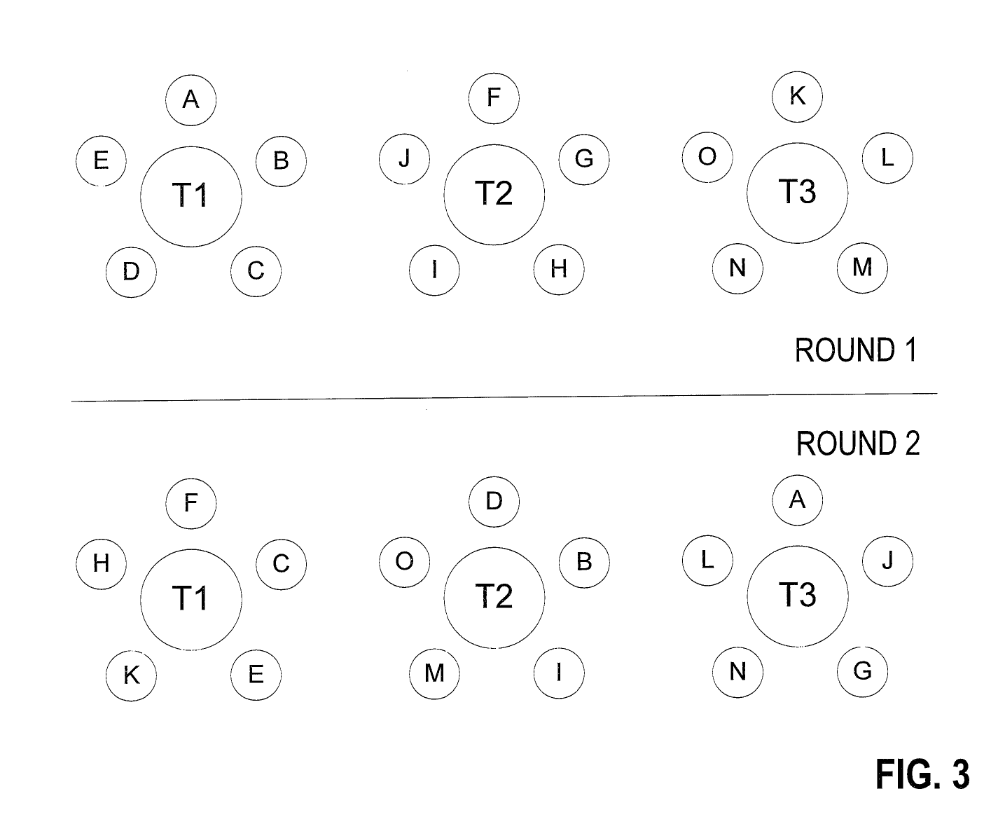

By way of overview and introduction, the present disclosure details systems and methods for coordinating a series of social encounters. Traditionally, individuals who visit restaurants and other such establishments interact with other individuals there based on previous connections and/or random encounters. However, existing approaches and methods of social interaction often do not yield high quality and mutually enjoyable connections for many people. Accordingly, the systems and methods disclosed herein serve to enhance the social experiences of all participating users, and provide the users with opportunities to connect with others with whom they are likely to be compatible. As can be appreciated with brief reference to the accompanying FIG. 3, in certain scenarios and settings, such as at a restaurant, one or more tables can be provided, such as tables T1-T3. Upon implementing the systems and/or methods disclosed herein, individuals such as users A-O can be directed to various seating positions at one of the various restaurant tables T1-T3. Additional features and functionalities are also provided that serve to facilitate communication among the various users A-O and further enhance the overall social experience enjoyed by the users, both during their time at the restaurant and afterwards. In addition, at periodic intervals the systems and/or methods disclosed herein can coordinate the rearrangement of the seating arrangements of the participating users (such as users A-O) across the provided restaurant tables (such as tables T1-T3), as can be appreciated when comparing ROUND 1 and ROUND 2 of FIG. 3. Such rearrangements can be computed based on various inputs provided by the users in order to further facilitate present and future social encounters and experiences that are likely to be mutually enjoyable to the participating users.

The following detailed description is directed to systems and methods for coordinating a series of social encounters. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Furthermore, the terms and phrases used herein are not intended to be limiting, but rather are to provide an understandable description of the systems and methods.

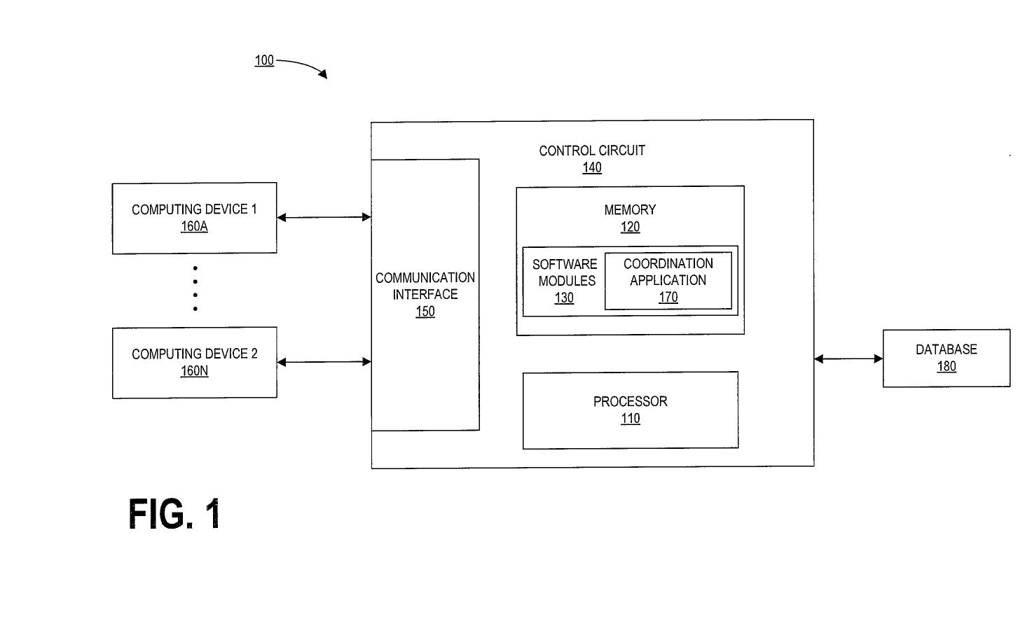

Referring now to the drawings, it is to be understood that like numerals represent like elements through the several figures, and that not all components and/or steps described and illustrated with reference to the figures are required for all embodiments or arrangements. It should also be understood that the embodiments and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system to configure the processor and/or other elements to perform the functions described below. Such a computer system typically includes memory storage configured to provide output from execution of the computer code, module or program. An exemplary computer system is shown as a block diagram in FIG. 1 which is a high-level diagram illustrating an exemplary configuration of a social encounter coordination system 100. In one arrangement, social encounter coordination system 100 can be a computer such as a personal computer or a server. In another arrangement, social encounter coordination system 100 can be a plurality of computers in communication with one another, though it should be understood that social encounter coordination system 100 can be practically any computing device capable of embodying the systems and/or methods described herein.

Social encounter coordination system 100 includes a control circuit 140 which is operatively connected to various hardware and software components that serve to enable operation of the social encounter coordination system 100. The control circuit 140 is operatively connected to a processor 110 and a memory 120. Preferably, memory 120 is accessible by processor 110, thereby enabling processor 110 to receive and execute instructions stored on memory 120.

One or more software modules 130 are encoded in memory 120. The software modules 130 can comprise a software program or set of instructions executed in processor 110. Preferably, included among the software modules 130 is a coordination application 170 that is executed by processor 110. During execution of the software modules 130, and specifically the coordination application 170, the processor 110 configures the control circuit 140 to coordinate a series of social encounters, as will be described in greater detail below. It should be noted that while FIG. 1 depicts memory 120 oriented on control circuit 140, in an alternate arrangement, memory 120 can be practically any storage medium (such as a hard disk drive, flash memory, etc.) that is operatively connected to the control circuit 140, even if not oriented on control circuit 140 as depicted in FIG. 1.

Also connected to control circuit 140 is a database 180. Database 180 receives, transmits, and stores data and/or information received by and/or pertaining to the operation of the social encounter coordination system 100, as will be described in greater detail below. Database 180 is preferably a computing device (such as a personal computer or server) and/or several connected computing devices with a storage medium that is capable of maintaining the data/information generated and/or received by social encounter coordination system 100. In an alternate arrangement, database 180 can be a data storage device such as a hard disk, or an array of storage devices (e.g., RAID). It should be noted that while FIG. 1 depicts database 180 as a being a stand-alone element that is communicatively connected to control circuit 140, in other arrangements database 180 can be oriented on control circuit 140, such as being incorporated into memory 120.

A communication interface 150 is also operatively connected to control circuit 140. Communication interface 150 can be any interface that enables communication between the control circuit 140 and external devices, machines and/or elements. Preferably, communication interface 150 is a network interface controller such as an Ethernet or wireless (802.11) network adapter, though it should be understood that communication interface 150 can be practically any interface that enables communication to/from the control circuit 140.

At various points during the operation of social encounter coordination system 100, control circuit 140 can communicate with one or more computing devices 160a-n (collectively computing devices 160). The computing devices 160 transmit and/or receive data to/from the control circuit 140, as will be described in greater detail below. While computing device 160 can be practically any device capable of communication with control circuit 140, in the preferred embodiment computing device 160 is a handheld/portable computer, smartphone, personal digital assistant (PDA), and/or any portable device that is capable of transmitting and receiving data to/from the control circuit 140. The user of computing device 160 preferably interacts with social encounter coordination system 100 through an application (‘app’) executing on the user's computing device 160. This application provides a simple and intuitive user interface that enables the user to receive, review, and input data, information, and/or settings that relate to the operation of the social encounter coordination system 100, as will be described in greater detail below. In an alternate arrangement, the user can communicate with social encounter coordination system 100 through a website and/or a web-based interface. In such an arrangement, the user need not execute the referenced application on his/her computing device 160, rather the referenced website enables substantially the same functionality through a web-interface.

It should be noted that while the FIG. 1 depicts the social encounter coordination system 100 with respect to computing device 160a and computing device 160n (generically, computing devices 160), it should be understood that any number of computing devices can interact with social encounter coordination system 100 in the manner described herein.

In the description that follows, certain embodiments and/or arrangements are described with reference to acts and symbolic representations of operations that are performed by one or more devices, such as the social encounter coordination system 100 of FIG. 1. As such, it will be understood that such acts and operations, which are at times referred to as being computer-executed, include the manipulation by the processor of the computer of electrical signals representing data in a structured form. This manipulation transforms the data and/or maintains them at locations in the memory system of the computer, which reconfigures and/or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments and/or arrangements may be described in a general context of computer-executable instructions, such as program modules, being executed by a computer. Generally, program modules include routines, programs, objects, components, data structures, etc., that perform particular tasks or implement particular abstract data types.

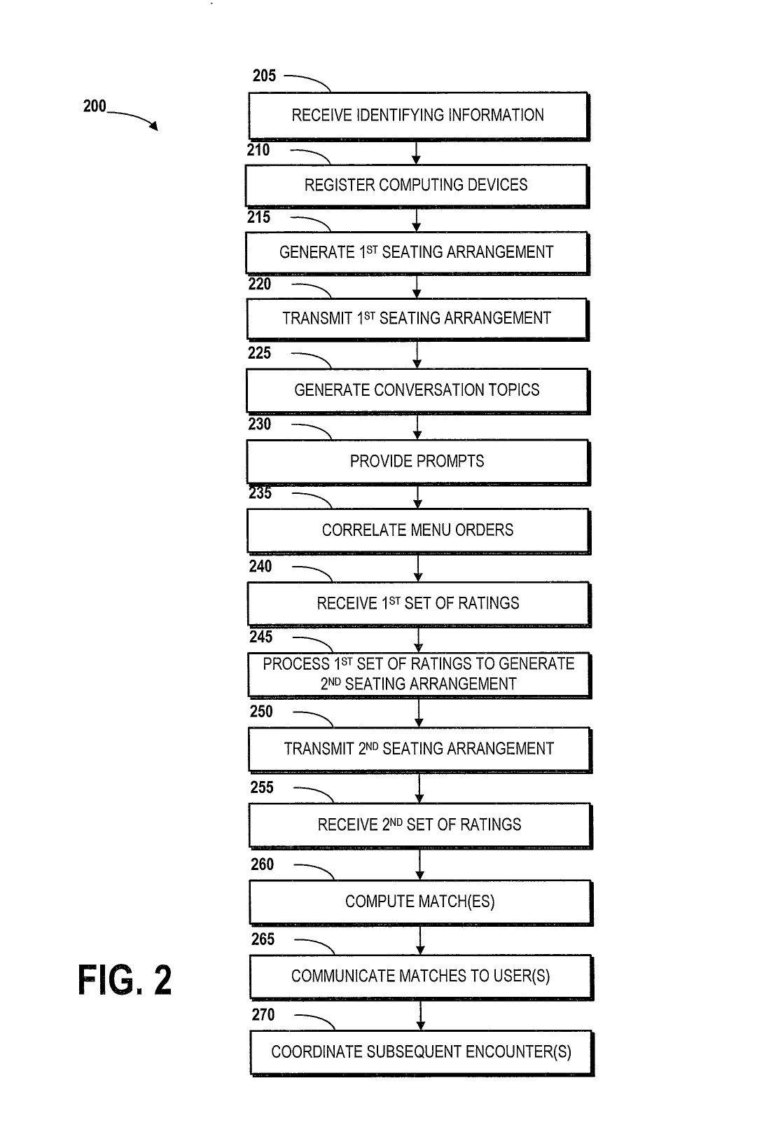

The operation of the social encounter coordination system 100 and the various elements described above will be further appreciated with reference to the method for coordinating a series of social encounters as described below, in conjunction with FIG. 2.

Turning now to FIG. 2, a flow diagram is described showing a routine 200 that illustrates a broad aspect of a method for coordinating a series of social encounters in accordance with at least one embodiment disclosed herein. It should be appreciated that several of the logical operations described herein are implemented (1) as a sequence of computer implemented acts or program modules running on social encounter coordination system 100 (and/or computing device 160) and/or (2) as interconnected machine logic circuits or circuit modules within the social encounter coordination system 100 (and/or computing device 160). The implementation is a matter of choice dependent on the requirements of the device (e.g., size, energy, consumption, performance, etc.). Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 205 where the user of a computing device 160 sends, and the social encounter coordination system 100 receives identifying information from the user. Preferably, the identifying information includes information such as the user's name, address, phone number, and email address, for example. Additional examples of identifying information can include educational and professional history, interests, hobbies, and responses to various other personal questions. In one arrangement, the identifying information can be provided in response to one or more questions, prompts, and/or input fields that are presented to the user at the computing device 160. The presentation of such questions, prompts, etc., can be achieved in any number of ways, such as through one or more webpages, or through an application (app) executing at the computing device 160 that is in communication with the social encounter coordination system 100. It should be noted that in certain arrangements the identifying information can include an image and/or video of the user (or any other such identifying media). In certain arrangements a camera (not shown) connected to social encounter coordination system 100 can capture such an image/video.

It should be understood that while in one arrangement the user of computing device 160 can provide the identifying information through one or more manual inputs, as described above, in other arrangements varying degrees of automation can be implemented that enable the user to provide identifying information in a more expedient fashion. For example, in one arrangement the user can be prompted to login and/or link their account/profile at a social networking site (such as Facebook or LinkedIn, for example), thereby providing the social encounter coordination system 100 with access (e.g., limited access) to the user's account/profile at the site. In such an arrangement, users can provide their identifying information in a greatly expedited fashion, and can also provide a greater degree of information that could be more difficult to reasonably obtain through the manual input method described above.

It should be further understood that while in certain arrangements the identifying information is communicated or otherwise transmitted from computing device 160 (such as a smartphone belonging to the user) to the social encounter coordination system 100, in other arrangements the identifying information can be provided by the user into a terminal (not shown) that is in communication with and/or integrated within social encounter coordination system 100. Alternatively, in certain arrangements an employee or administrator of social encounter coordination system 100 can present a series of questions to the user, and can input the responses provided by the user into a terminal in communication with social encounter coordination system 100. Such an arrangement enables users who are not presently in possession of a computing device to interact with the social encounter coordination system 100.

At step 210, one or more computing devices 160 are registered with the social encounter coordination system 100. Additionally, each respective computing device 160 is preferably associated or otherwise linked to a set of identifying information provided in step 205. Doing so enables social encounter coordination system 100 to communicate and/or otherwise interact with each respective computing device 160 on the basis of the identifying information provided by the user. Additionally, in a scenario where a user is not in possession of a computing device 160 (as described above) a temporary computing device 160 can be provided to such a user, and the temporary computing device 160 can be associated with the identifying information provided by the user (such as into a terminal, as described above). It should also be understood that any number of unique identification numbers, codes, and/or methods can be used and/or implemented in the registration of the computing devices 160 with the social encounter coordination system 100, including but not limited to ESNs, MEIDs, pESNs, and MAC addresses. Additionally, in certain arrangements computing device 160 can be registered with social encounter coordination system 100 by capturing a Quick Response (QR) code or barcode with an image capture device (e.g., a camera) integrated within computing device 160. By correlating information from the captured QR or barcode with identifying information from the computing device 160, and communicating this correlated information to social encounter coordination system 100, computing device 160 can be registered with social encounter coordination system 100 in an expedient manner. Moreover, the QR or barcode can be associated with a particular individual or identity within social encounter coordination system 100 (such as a user that has just registered at a terminal, as described above). Upon capturing the QR or barcode at computing device 160 (such as a computing device that is provided to a user on a temporary basis), the computing device 160 can be registered with the individual or identity associated with the particular QR or barcode.

Then, at step 215, the social encounter coordination system 100 generates a first seating arrangement in the memory 120. The first seating arrangement preferably includes a first grouping of users that have provided identifying information (such as at step 205) and/or registered their computing devices 160 (such as at step 210), as well as one or more first seating assignments that denote a specific location or area where a particular user is directed to sit. The referenced seating arrangements, groupings, and seating assignments can be further appreciated with reference to FIG. 3.

FIG. 3 is an exemplary diagram illustrating the generation and implementation of seating arrangements, grouping, and seating assignments as described with respect to FIG. 2. Tables T1, T2 and T3 are tables, such as at a restaurant or other such venue, where the various users A-O are directed to sit in accordance with one or more seating assignments provided by the social encounter coordination system 100, as described herein. It should be understood that while each of tables T1-T3 depict five users seated at each respective table, various other configurations are possible, including implementing tables that do not hold the same number of users (e.g., one table for six users, one table for four users, and one table for two users).

FIG. 3 depicts two sets of seating arrangements, denoted in FIG. 3 as ‘ROUND 1’ and ‘ROUND 2.’ It should be understood that while only two sets (‘rounds’) of seating arrangements are depicted in FIG. 3, any number of greater or fewer sets of seating arrangements are similarly possible. ROUND 1 refers to an initial set of seating arrangements of users A-O at tables T1-T3. Considering, by way of example, table T1, it can be appreciated that users A-E have been grouped together (thus comprising a first grouping) and have further been assigned to table T1 (which can be said to be their first seating assignment). Accordingly, it can be appreciated that a given seating arrangement can be said to be made up of a grouping of one or more users (such as users A-E) which is in turn assigned to a specific table (such as table T1).

At this juncture, it should be understood that there are any number of ways that social encounter coordination system 100 can generate a seating arrangement or a set of seating arrangements such as those depicted in FIG. 3. In one arrangement, a seating arrangement can be generated at random. That is, the grouping (i.e., the users) and seating assignment (i.e., the table) that make up the seating arrangement can be selected at random from among the available users and tables known to and/or stored by social encounter coordination system 100. Such a random seating arrangement may be of particular interest in an initial encounter scenario where the various users do not know one another, and it is not yet known how the various users will interact with one another. In other arrangements, various aspects of the identifying information provided by the users (as referenced above) can be processed by the social encounter coordination system 100 in order to identify users that may have a higher likelihood of establishing a mutually positive social connection, such as users which share similar or complementary interests and/or backgrounds.

Upon generating a first seating arrangement, the process continues to step 220, where the social encounter coordination system 100 transmits, such as through communication interface 150, and each of the computing devices 160 preferably receives, a first seating assignment. As referenced above, the seating assignment is preferably a particular location, such as a specific table, at which the user is directed to sit. It can be understood, especially with reference to FIG. 3, that the first seating assignment will often vary from user to user. Thus, in ROUND 1 of FIG. 3, user C will receive a seating assignment of table T1, while user M will receive a seating assignment of table T3. The seating arrangement is preferably presented to the respective user as a prompt or other such notification within and/or triggered by an application (app) executing at the respective user's computing device 160, though it should be understood that other notification methods (such as SMS, email, and instant message) can be similarly employed. Upon receiving the first seating arrangement, the user is expected to act in accordance with the directions contained in the seating arrangement. In certain arrangements, such as in a restaurant, it is contemplated that a first course will be served to each of the tables T1-T3.

Then, at step 225, the social encounter coordination system 100 generates one or more conversation topics which are intended to enhance the social experience of the users seated at the tables. In certain arrangements, the conversation topics can be generated based on the identifying information provided by the various users, as referenced above with respect to step 205. Thus, for instance, with reference to ROUND 1 in FIG. 3, the social encounter coordination system 100, having receiving identifying information from user F at step 205 indicating that user F enjoys baseball, can generate a conversation topic for table T2 (at which user F is seated) regarding baseball. It is expected that generating conversation topics based upon information that is of interest to one or more of the users seated at a respective table will increase the likelihood that the users at the table will engage one another in conversation.

It should be noted that the conversation topics generated by the social encounter coordination system 100 at step 225 can be generated in any number of ways. For instance, in the example presented above (where it is known that user F enjoys baseball), the social encounter coordination system 100 can further access and integrate third-party information into the conversation topics being generated. Thus, being that user F enjoys baseball, the social encounter coordination system 100 can query an external information source, such as a sports reporting website (e.g., ESPN.com) and obtain relevant and timely information (such as recent sports scores) that relate to baseball. Accordingly, the social encounter coordination system 100 can generate a conversation topic such as ‘Did you see the New York Yankees game last night?’ In other arrangements, conversation topics can be generated based solely upon third-party information, such as news headlines, with little or no regard for the specific identification information provided by the users at a given table. In any event, such arrangements can further enhance the ability of social encounter coordination system 100 to create a lively social environment among the users seated at each of the various tables.

As another example, the system 100 can provide a questionnaire to the users either at the venue or in advance, and the response is used to coordinate seating assignments as well as topics of conversation.

Additionally, it should be noted that multiple conversation topics can be generated, and that the conversation topics can be prioritized based on the degree of interest each topic is expected to have among the various users seated at a given table. Thus, for example, with reference to ROUND 1 in FIG. 3, if users K, M, and O at table T3 have provided identifying information indicating that they enjoy music, while user L and N have each provided identifying information indicated that they enjoy traveling, a conversation topic relating to music can be prioritized higher than a topic on traveling, in light of the greater perceived interest in music among the various users.

Then, at step 230, one or more prompts can be provided to at least one of the computing devices 160. The prompts preferably include at least one of the conversation topics generated at step 225. In one arrangement, the prompts can be provided to a specific and/or single user, while in other arrangements the prompts can be provided to a plurality of users and/or all of the users, such as all those seated at a particular table. For instance, using the example referenced above, if it is known that both users L and N at table T3 enjoy traveling, user L may be prompted to ask user N about user N's recent travels. In an alternate arrangement, each of users K-O at table T3 can receive a prompt suggesting a conversation topic relating to music. It should be noted that the prompt provided to the one or more computing devices 230 is preferably a notification within and/or triggered by an application (app) executing at the respective user's computing device 160, though it should be understood that other prompting methods (such as SMS, email, and instant message) can be similarly employed.

It should be noted that while in certain arrangements the prompts (containing at least one of the generated conversation topics) can be provided at pre-defined intervals and/or occasions, in other arrangements the prompts can be provided in response to the detection of one or more specific events and/or stimuli. By way of example, in one arrangement the integrated microphones of computing devices 160 (such as in the case of smartphones which include microphones) can be utilized by social encounter coordination system 100 to detect and/or monitor a noise level within a location, such as at a table. The computing device(s) 160 can transmit, such as through an application (app) executing on the respective computing device(s) 160, one or more noise levels detected by the microphone of the respective computing device 160. Using the noise level(s) provided by the computing devices 160, the social encounter coordination system 100 can determine an opportune time to provide the one or more prompts having conversation topics. Thus, by way of example, if one or more computing devices detect a low noise level at a particular table, based on this information social encounter coordination system 100 can dynamically provide a prompt to stimulate conversation among the users at the particular table. In certain arrangements, the prompt can be provided to all users at a given table, as discussed above. In other arrangements, if a certain noise level is detected at a particular computing device (e.g., a noise level that is lower than the average noise level of the other users at the table), the prompt containing a generated conversation topic can be provided to the computing device 160 registered to that particular user, thereby facilitating his/her inclusion in the conversation between the other users at the table. Conversely, in yet another arrangement, if a lower than average noise level is detected at the computing device 160 of a particular user, a prompt can be provided to one or more of the other users seated at the same table, prompting them with a conversation topic that has been generated based upon identifying information or any questionnaire responses provided by the user that has been detected to have a lower than average noise level at his/her computing device 160. In this way the social encounter coordination system 100 can facilitate the participation of as many of the users as possible in a conversation.

At step 235, the social encounter coordination system 100 correlates one or more menu orders with one or more respective seating assignments. Considering that the present system and method can be employed in a setting such as a restaurant, it is advantageous for the social encounter coordination system 100 to correlate the order(s) of a particular user with that user's seating assignment, especially considering that the user may change tables, as will be described in greater detail below. Accordingly, the social encounter coordination system 100 can correlate, either in conjunction with an existing order management system, or independently, menu orders placed by the users. By way of example, prior to receiving a first seating assignment, user E may order a drink. However, prior to receiving the drink, user E receives a first seating assignment, instructing him to sit at table T1, as depicted at ROUND 1 in FIG. 3. By correlating the menu order (here, user E's drink) with a user's seating assignment (here, table T1), the social encounter coordination system 100 is able to quickly direct restaurant employees to the appropriate table, despite the dynamic nature of the seating assignments, as will be described in greater detail below. Similarly, user J may order an appetizer while seated at table T2 at ROUND 1, but the appetizer may not be ready to serve until user J is seated at table T3 at ROUND 2. Again, by correlating user J's menu order with his/her seating assignment, the social encounter coordination system 100 can dictate the proper location to direct a particular order despite the changing seating assignments, as will be described in greater detail below. In this regard the system 100 can integrate with restaurant point of sale (POS) modules such as “Dinerware,” by Dinerware, Seattle, Wash., “PointOS Professional” by PointOS, “Halo” by Vivonet, or “Cash Register Express” by PC America, each of which comprise software that provides a restaurant POS system featuring ticket handling, order routing, menus, business policies, labor management functionality, and so on.

Then, at step 240, the one or more computing devices 160 transmit, and the social encounter coordination system 100 receives a first set of ratings of one or more users in a given grouping (preferably the same grouping as the user providing the ratings). By way of example, an application (app) executing at the various computing devices 160 can prompt each respective user to provide ratings of the other users seated at his/her table. In certain arrangements, this prompt can be provided at a specified time (for example, 15 minutes after the users have been seated), or at a time dictated by social encounter coordination system 100 (which can in turn be dictated by menu order status, e.g., that all seated users have received their orders, or by an administrator's observation and instruction to social encounter coordination system 100 that the first round should conclude).

It should be understood that any number of rating mechanisms and schemes can be implemented. For instance, in one arrangement, each user can be presented (within the interface of an application executing on his/her computing device 160) with a list of each user seated at the user's table along with a photo of each of the users (if available, preferably as provided at step 205 as described above). Next to the name/photo of each user is a rating scheme, such as a numerical (1-10), alphabetic (A-F), or symbolic (‘thumbs up,’ ‘thumbs down’) rating. The user is prompted to provide a rating for each user seated at his/her table, and the ratings are then transmitted to social encounter coordination system 100, as described above. It should be noted that in certain arrangements, a user can elect to abstain from rating one or more users (such as through a ‘thumbs sideways’ rating option, for example). The significance of such an abstention will be described in greater detail below. Additionally, it should be noted that although the discussion above has referenced providing a single rating for each user, in other arrangements a user can provide multiple ratings for each user corresponding to multiple rating categories (for example, multiple rating categories, such as appearance, personality, compatibility, etc., can be presented for each user).

At step 245, the social encounter coordination system 100 processes the first set of ratings using the coordination application 170. In doing so, the coordination application 170 analyzes the ratings received at step 240, specifically by comparing the one or more ratings provided by a first user regarding a second user with the rating(s) provided by the same second user regarding the first user. In doing so, the coordination application can identify if a mutual interest exists between two users. By way of example, in ROUND 1 of FIG. 3, users B and D are seated at table T1. As described above with regard to step 240, it is expected that user B will provide a rating for user D, and vice versa. Accordingly, upon receiving the ratings from users B and D, coordination application 170 can compare the two ratings. If user B has provided a positive rating (such as ‘thumbs up’) for user D, and user D has similarly provided a positive rating for user D, coordination application 170 can identify users B and D as a potential match. In doing so, coordination application 170 can generate a second seating arrangement. The second seating arrangement, similar to the first seating arrangement described above, comprises a second grouping of the various users that is preferably different from the first grouping of the users (as described above with regard to step 215 and depicted at ROUND 1 of FIG. 3) and one or more second seating assignments that are different from the first seating assignments (also described above with regard to step 215 and depicted at ROUND 1 of FIG. 3). Following the example referenced above with regard to users B and D (seated at table T1 at ROUND 1 of FIG. 3), upon identifying users B and D as a potential match, the coordination application 170 can generate a second seating arrangement for users B and D at table T2, as depicted at ROUND 2 of FIG. 3.

With regard to the option referenced above, wherein a user can elect to abstain from rating one or more users (such as through a ‘thumbs sideways’ rating option, for example), in certain arrangements such an abstention can have the effect of reciprocating a rating received from a particular user back to that same user. That is, for example, users M and O (seated at table T3 at ROUND 1 in FIG. 3) are expected to provide ratings for one another. If user M provides a positive rating for user O while user O abstains from providing a rating for user M (such as by providing a ‘thumbs sideways’ rating), the positive rating that user M provided for user O can be reciprocated such that social encounter coordination system 100 can consider it as if user O provided a corresponding positive rating for user M. In doing so, a user can effectively default his/her rating of another user to the same rating as that particular user provides him/her with. It should be noted that in certain arrangements, in a scenario where both users abstain from rating one another, such ratings can either be considered as positive ratings, as negative ratings, and/or simply not counted as ratings, depending on the configuration of the system.

At this juncture, it should be noted that any number of factors can be considered and processed by coordination application 170 in order to generate the second seating arrangement. For example, in addition to seating potential matches with each other within the second seating arrangement (such as that of users B and D, as described above), coordination application 170 can also consider other information (including the identifying information discussed above with respect to step 205) in generating the second seating arrangement. Thus, for example, if both users B and D are known to enjoy movies, coordination application 170 can seat them with other users who share that interest (for example, users I, M, and O at ROUND 2 of FIG. 3). Additionally, in certain arrangements, coordination application 170 can correlate one user's rating of another user with the respective identifying information provided by each user. Thus, for example, if users C and E (seated at table T1 at ROUND 1 of FIG. 3) have both rated one another positively (resulting in a preliminary match), yet it is known, based on the identifying information provided, that user C enjoys classical music while user E does not, it can be assumed that the user C's interest in classical music (and user E's lack thereof) are not critical factors for either user (considering their potential match despite their divergent interests). Accordingly, coordination application 170 can generate a second seating arrangement (including users K, H, and F, as depicted at ROUND 2 of FIG. 3) with no regard for the remaining user's feelings toward classical music.

Additional factors that can be considered and processed by coordination application 170 include an aggregate rating for one or more users. That is, if a particular user has been rated positively by a large number of users, it can be expected that such a user will likely provide a positive experience for the other users seated with him/her. Conversely, if a particular user has been rated negatively by a large number of users, such a user may provide a negative experience for those seated with him/her. Accordingly, the coordination application 170 can consider these factors, by attempting to maintain a relative rating equilibrium within a given seating arrangement, specifically with regard to attempting to temper the effect of users with largely negative ratings with users with primarily positive ratings. For instance, in ROUND 1 in FIG. 3, if user D (seated at table T1) receives mostly negative ratings from those seated at table T1, while user O receives mostly positive ratings from the users at table T3, coordination application 170 can attempt to offset the user D's negative ratings by seating users D and O together at table T2 (as depicted in ROUND 2 of FIG. 3). In doing so, the coordination application 170 can ensure that as many users as possible have a positive social experience.

Still other factors can include statistical information regarding the noise level detected at each user device 160 which can provide an indication of extravertedness or intravertedness, and the data can be coordinated with the timing of any conversation prompts to try to identify persons who speak when prompted with reaction topics (e.g., Hollywood news, etc.).

Then, at step 250, the social encounter coordination system 100 transmits, such as through communication interface 150, and each of the computing devices 160 preferably receive, a second seating assignment, substantially in the same way as the first seating assignment, as described in detail above with respect to step 220. However, it is expected that the second seating assignment will incorporate information from the first set of ratings (received at step 240 and processed at step 245), in addition to the identifying information (provided at step 205), and the second seating assignment will thus be preferable to at least some of the users.

At step 255, the one or more computing devices 160 transmit, and the social encounter coordination system 100 receives, a second set of ratings of one or more users in a given grouping (preferably the same grouping as the user providing the ratings), in substantially the same manner as described in detail above with respect to step 240.

At this juncture it should be noted that in various arrangements the process of steps 215-255 (including but not limited to the generating of seating assignments, the transmitting of the seating assignments, the generating of conversation topics, the providing of prompts, the receiving of sets of ratings, and the processing of ratings to generate further seating assignments) can be repeated any number of times. It can be understood that the more times the process is repeated, the greater the likelihood that the participating users will create meaningful social connections. Additionally, such an arrangement can be easily configured to a meal provided by a restaurant with a certain number of courses (each round or iteration corresponding to a different course).

Then, at step 260, the coordination application 170 can compute one or more matches, preferably based on at least the various sets of ratings received from the users. In doing so, the coordination application 170 compares the ratings provided by a first user regarding a second user with the corresponding ratings provided by the second user regarding the first user, in a manner substantially similar to that discussed above with respect to step 245. In doing so, the coordination application 170 can identify a mutual interest between two users. In certain arrangements coordination application 170 can further consider aspects of the identifying information, also in a manner substantially similar to that disclosed above with respect to step 245. By way of example, coordination application 170 can consider the distance between the residence of one user and another (computed based on the addresses provided by each user) in determining a match. It should be noted that in certain arrangements the social encounter coordination system 100 can be configured to compute only a single match for each user (if applicable), while in other arrangements the social encounter coordination system 100 can be configured to compute any number of matches for a given user.

At step 265, the matches (generated at step 260) are communicated to each respective user. That is, each user will receive notification of a match that corresponds to him/her. The matches can be communicated in any number of ways. In one arrangement, the matches can be communicated to the user through an application executing on his/her computing device 160 (such as the application referenced above), while in other arrangements the matches can be communicated through other means such as email, SMS message, and/or status update to a social networking site/profile. In certain arrangements the social encounter coordination system 100 can also be configured to communicate the matches only after a certain time interval/delay in order to avoid/prevent any potentially unpleasant social situations that could arise as a result of having the matches communicated to the users immediately.

It should be noted that in certain arrangements the notification of a match will include contact information and/or additional identifying information regarding the matched user. Preferably, each user, when providing the identifying information, can establish preferences as to the degree and/or amount of information that will be provided to a matched user. In other arrangements the notification of a match will enable the matched users to communicate with one another through a messaging portal provided by the social encounter coordination system 100. In doing so, the social encounter coordination system 100 can monitor and/or maintain the integrity of the contact between the matched users.

After receiving the matches, at step 270 the social encounter coordination system 100 can further facilitate social interaction among the users by coordinating one or more subsequent encounters. In certain arrangements, the social encounter coordination system 100 will be configured such that only users who have been designated as matches can coordinate subsequent encounters with one another. In other arrangements, the social encounter coordination system 100 can enable the coordination of subsequent encounters across a broader range of users, for example, users who were seated with one another at some point, or all users who did not provide negative ratings for one another. Social encounter coordination system 100 can preferably enable users (such as through access via a website or communication with an application executing on a computing device 160) to propose, initiate, and/or otherwise coordinate social encounters, such as going to movies, restaurants, and/or events. In certain arrangements the social encounter coordination system 100 can be configured with various information repositories having socially-relevant data such as movie schedules, restaurant listings, concert listings, etc., which can easily enable users to select and propose social encounters to other users.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A computer-implemented method for coordinating a series of social encounters using a central machine, the central machine having a processor, a memory, and a coordination application stored in the memory and executing in the processor, the central machine further being in communication with one or more computing devices, the method comprising:
receiving identifying information corresponding to one or more users and correlated with respective computing devices;
generating a first seating arrangement in the memory, the first seating arrangement comprising a first grouping of the users and one or more first seating assignments;
transmitting a first seating assignment to each of the computing devices;
receiving a first set of ratings of one or more users in the first grouping from computing devices of one or more users in the first grouping;
processing the first set of ratings to generate a second seating arrangement in the memory, the second seating arrangement comprising a second grouping of the users that is different from the first grouping of the users and one or more second seating assignments that are different from the one or more first seating assignments;
transmitting a second seating assignment to each of the computing devices;
receiving a second set of ratings of at least one of the users from each of the computing devices; and
based on at least the first set of ratings and the second set of ratings, computing one or more matches.

2. The method of claim 1, further comprising registering the computing devices with the central machine.

3. The method of claim 1, further comprising:
generating one or more conversation topics based on the identifying information; and
providing one or more prompts to at least one computing device, the prompts comprising the one or more conversation topics.

4. The method of claim 3, further comprising:
monitoring a noise level at at least one computing device;
wherein the providing step comprises providing the one or more prompts in response to the noise level.

5. The method of claim 1, further comprising correlating one or more menu orders with one or more respective first seating assignments.

6. The method of claim 5, further comprising further correlating the one or more menu orders with one or more respective second seating assignments.

7. The method of claim 1, further comprising communicating the one or more matches to a user.

8. The method of claim 1, wherein the identifying information comprises a social network profile.

9. The method of claim 1, wherein the identifying information comprises one or more responses to one or more questions relating to a user's personal interests or personal preferences.

10. The method of claim 1, wherein the first set of ratings comprises a rating corresponding to a first user's opinion of a second user.

11. The method of claim 1, wherein the second set of ratings comprises a rating corresponding to a first user's opinion of a second user.

12. The method of claim 1, wherein the processing step comprises comparing a first user's rating of a second user with the second user's rating of the first user.

13. The method of claim 1, further comprising coordinating a subsequent encounter based on the one or more matches.

14. A social encounter coordination system comprising:
a processor;
a control circuit operatively connected to the processor;
a memory operatively connected to the control circuit and accessible by the processor;
a coordination application stored in the memory and executable in the processor; and
a communication interface operatively connected to the control circuit and configured for communication with one or more computing devices;
wherein the coordination application, when executed by the processor, configures the control circuit to:
receive identifying information corresponding to one or more users and correlated with respective computing devices;
generate a first seating arrangement in the memory, the first seating arrangement comprising a first grouping of the users and one or more first seating assignments;
transmit with the communication interface a first seating assignment to each of the computing devices;
receive a first set of ratings of one or more users in the first grouping from computing devices of one or more users in the first grouping;
process the first set of ratings to generate a second seating arrangement in the memory, the second seating arrangement comprising a second grouping of the users that is different from the first grouping of the users and one or more second seating assignments that are different from the one or more first seating assignments;
transmit a second seating assignment to each of the computing devices;
receive a second set of ratings of at least one of the users from each of the computing devices; and
compute one or more matches based on at least the first set of ratings and the second set of ratings.
